(19) United States
(12) Patent Application Publication
(10) Pub. No.: US 2019/0278281 A1
(43) Pub. Date: Sep. 12, 2019

(54) VEHICLE, METHOD FOR CONTROLLING VEHICLE, AND COMPUTER PROGRAM

(71) Applicant: NIDEC-SHIMPO CORPORATION, Kyoto (JP)

(72) Inventor: Takeshi Sakai, Kyoto (JP)

(73) Assignee: NIDEC-SHIMPO CORPORATION, Kyoto (JP)

(21) Appl. No.: 16/283,840

(22) Filed: Feb. 25, 2019

(30) Foreign Application Priority Data
Feb. 26, 2018 (JP) 2018-031911

(51) Int. Cl. G05D 1/02; G05D 1/00; B60L 58/12; G07C 5/08

(52) U.S. Cl. CPC G05D 1/0217; G05D 1/0011; G07C 5/0816; G07C 5/0841; B60L 58/12

(57) ABSTRACT

This disclosure provides a vehicle, a method for controlling vehicle and a non-transitory computer readable medium stored with a computer program for controlling vehicle. The vehicle performs travel along a predetermined route in a plurality of cycles. The vehicle includes an electrical storage device; a driving device; a communication circuit for performing wireless communications; and a control circuit for monitoring a remaining energy of the electrical storage device and controlling the driving device and the communication circuit. When starting travel along the route, the control circuit causes the driving device to start the travel if the remaining energy of the electrical storage device exceeds a threshold value or causes the communication circuit to transmit an alert if the remaining energy does not exceed the threshold value. The threshold value is set on the basis of the amount of energy consumed by at least one cycle of travel in the past.

### CROSS REFERENCE TO RELATED APPLICATIONS

This application claims the priority benefit of Japanese Patent Application No. 2018-031911, filed on Feb. 26, 2018. The entirety of the above-mentioned patent application is hereby incorporated by reference herein and made a part of this specification.

### TECHNICAL FIELD

The present disclosure relates to a vehicle.

### DESCRIPTION OF THE RELATED ART

Research and development of vehicles capable of moving autonomously, such as automated guided vehicles or mobile robots, are under way. In many cases, such a vehicle is driven by one or more electric motors. The electric motor operates with electric energy that is stored in an electrical storage device, such as a secondary battery or a capacitor. Japanese Laid-Open Patent Publication No. 2014-150618 discloses an example of an automated guided vehicle that operates by using a secondary battery as a power supply.

### SUMMARY

The present disclosure provides a novel technology for early discovering of a shortage of stored energy in a vehicle that repeatedly travels along a predetermined route.

A vehicle according to an embodiment of the present disclosure performs travel along a route that is predetermined in a plurality of cycles. The vehicle includes an electrical storage device; a driving device, configured to move the vehicle using an electric energy stored in the electrical storage device; a communication circuit, configured to perform a wireless communication; and a control circuit, configured to monitor a remaining energy of the electrical storage device and to control the driving device and the communication circuit. When starting travel along the route, the control circuit compares the remaining energy of the electrical storage device against a threshold value, and causes the driving device to start the travel if the remaining energy exceeds the threshold value, and causes the communication circuit to transmit an alert if the remaining energy does not exceed the threshold value. The threshold value is set on the basis of an amount of energy consumed by at least one cycle of travel in the past.

The general or specific aspects in this disclosure may be implemented using a device, a system, a method, an integrated circuit, a computer program, or a storage medium. Alternatively, those aspects may also be implemented using arbitrarily combining a device, a system, a method, an integrated circuit, a computer program and a storage medium.

According to an embodiment of the present disclosure, it is possible to discover early on a shortage of stored power in a vehicle that repeatedly travels along a predetermined route.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 is a view showing an outline of a control system for controlling the travel of respective AGVs according to the present disclosure.

FIG. 2 is a view showing an example of an area S in which AGVs are present.

FIG. 3A is a view showing an AGV and a trailer before being connected together.

FIG. 3B is a view showing an AGV and a trailer having been connected together.

FIG. 4 is a view showing an external appearance of an exemplary AGV according to the present embodiment.

FIG. 5A is a view showing a first example hardware construction of the AGV.

FIG. 5B is a view showing a second example hardware construction of the AGV.

FIG. 6A is a view showing the AGV generating a map while moving.

FIG. 6B is a view showing the AGV generating a map while moving.

FIG. 6C is a view showing the AGV generating a map while moving.

FIG. 6D is a view showing the AGV generating a map while moving.

FIG. 6E is a view showing the AGV generating a map while moving.

FIG. 6F is a view schematically showing a part of a completed map.

FIG. 7 is a view showing an example in which one floor map is composed of a plurality of partial maps.

FIG. 8 is a view showing an example hardware construction of a navigation management device.

FIG. 9 is a schematic view showing an exemplary traveling path of the AGV that is determined by the navigation management device.

FIG. 10 is a view showing an example of a route along which the AGV travels.

FIG. 11 is a flowchart showing a first example of the operation of the AGV.

FIG. 12 is a flowchart showing a second example of the operation of the AGV.

FIG. 13 is a flowchart showing a third example of the operation of the AGV.

FIG. 14 is a flowchart showing a fourth example of the operation of the AGV.

FIG. 15 is a flowchart showing an example of the operation of the management device.

### DESCRIPTION OF EMBODIMENTS

### Terms

Before the explanation of an embodiment of the present disclosure, the definitions of the terms used in this specification will be explained.

An “automated guided vehicle” (AGV) means an unguided vehicle configured to automatically travel to a designated place. Goods may be loaded on and unloaded from the main body of the AGV by manpower or automatically. The notion of an “automated guided vehicle” includes an unmanned tractor unit and an unmanned forklift.

The term “unmanned” means a state in which no person is required to steer a vehicle, and does not preclude the vehicle from carrying a person(s) (for example, a person(s) who will load and unload cargo).

An “unmanned tractor unit” is an unguided vehicle that travels automatically to a designated place while dragging a cart, onto/from which cargo is loaded and unloaded by manpower or automatically.

An “unmanned forklift” is an unguided vehicle equipped with a mast along which a fork for transferring cargo, etc., is raised or lowered, such that cargo is loaded on the fork automatically; the vehicle automatically travels to a designated place; and the cargo is loaded and unloaded automatically.

An “unguided vehicle” is a vehicle equipped with one or more electric motors or one or more engines for rotating the wheels thereof.

A “vehicle” is a device that is capable of traveling while being loaded with a person(s) or cargo, and is equipped with a driving device, such as wheels for generating traction for travel, a biped or multiped device, or a propeller. The term “vehicle” in the present disclosure includes not only an automated guided vehicle in a limited sense but also a mobile robot, a service robot, and a drone.

The notion of “automated travel” includes: travel based on instructions from a navigation management system; and autonomous travel by a control device within the automated guided vehicle. The navigation management system may be a computer to which the automated guided vehicle is connected via communications technologies. Autonomous travel includes not only traveling of the automated guided vehicle to a destination along a predetermined path, but also traveling in a manner of following a moving target to be followed. Furthermore, the automated guided vehicle may temporarily perform manual travel on the basis of instructions from a worker. In the general sense of the term, “automated travel” should include both “guided type” travel and “guideless type” travel; for the purpose of the present disclosure, however, “automated travel” will mean “guideless type” travel.

The “guided type” is said of a system in which guiding signs are provided continuously or continually, such that an automated guided vehicle is guided by the use of the guiding signs.

The “guideless type” is said of a system in which an automated guided vehicle is guided without any guiding signs being provided. The automated guided vehicle according to an embodiment of the present disclosure is equipped with a localization device and can travel as the guideless type.

A “localization device” is a device for estimating its own position on an environment map on the basis of sensor data acquired by an external sensor, such as a laser range finder.

An “external sensor” is a sensor for sensing the external state of a vehicle. Examples of external sensors include a laser range finder (also referred to as a range-finding sensor), a camera (or an image sensor), a LIDAR (Light Detection and Ranging) device, a millimeter wave laser, and a magnetic sensor.

An “internal sensor” is a sensor for sensing the internal state of a vehicle. Examples of internal sensors include a rotary encoder (hereafter may be simply referred to as an “encoder”), an acceleration sensor, and an angular acceleration sensor (for example, a gyro sensor).

“SLAM” is an abbreviation of Simultaneous Localization and Mapping, and means that localization and environment map generation are performed simultaneously.

An “electrical storage device” means a device for storing electric energy. Examples of electrical storage devices include a secondary battery and an electrical storage capacitor. Examples of secondary batteries include rechargeable storage batteries, such as a lithium ion battery, a nickel cadmium battery and a lead-acid battery. Examples of electrical storage capacitors include capacitors having relatively large capacities, such as a lithium ion capacitor and an electric double layer capacitor.

### Exemplary Embodiments

Exemplary constructions for vehicles and vehicle management systems according to embodiments of the present disclosure will be described below referring to the accompanying drawings. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art. The accompanying drawings and the following description, which are provided by the inventors so that those skilled in the art can sufficiently understand the present disclosure, are not intended to limit the scope of claims. In the present specification, identical or similar constituent elements are denoted by identical reference numerals.

In the following descriptions, it is assumed that the vehicle is an automated guided vehicle, which will be described as “AGV”. Furthermore, the following descriptions are similarly applicable to vehicles other than AGVs, such as a robot or a manned vehicle having a plurality of drive wheels, unless there is any contradiction.

(1) The Basic Construction of the System

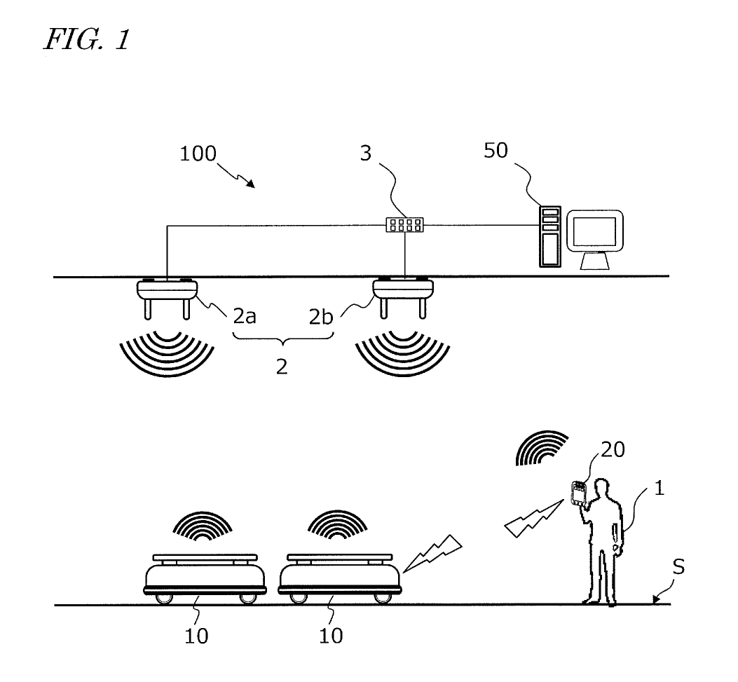

FIG. 1 shows an example of the basic construction of an exemplary vehicle management system 100 according to the present disclosure. The vehicle management system 100 includes at least one AGV 10 and a navigation management device 50 that manages navigation of the AGV 10. FIG. 1 also shows a terminal device 20 that is manipulated by a user 1.

The AGV 10 is an automated guided cart capable of performing “guideless” travel without requiring guiding signs, e.g., magnetic tapes, during travel. The AGV 10 can perform localization and can transmit the results of localization to the terminal device 20 and the navigation management device 50. The AGV 10 can perform automated travel in an area S according to instructions from the navigation management device 50.

The navigation management device 50 is a computer system that tracks the position of, and manages the travel of, each AGV 10. The navigation management device 50 may be a desk top PC, a laptop, and/or a server computer. The navigation management device 50 communicates with each AGV 10 via a plurality of access points 2. For example, the navigation management device 50 transmits, to each AGV 10, data of the coordinates of the position to which each AGV 10 is headed next. Each AGV 10 transmits data indicating the position and attitude (orientation) of itself to the navigation management device 50 periodically, for example, every 100 msec. When the AGV 10 reaches the designated position, the navigation management device 50 transmits data of the coordinates of the position to which the AGV 10 is headed further next. The AGV 10 can also travel in the area S according to a manipulation by the user 1 as input to the terminal device 20. An example of the terminal device 20 is a tablet computer. Typically, the travel of the AGV 10 using the terminal device 20 is performed at the time of map generation, and the travel of the AGV 10 using the navigation management device 50 is performed after the map generation.

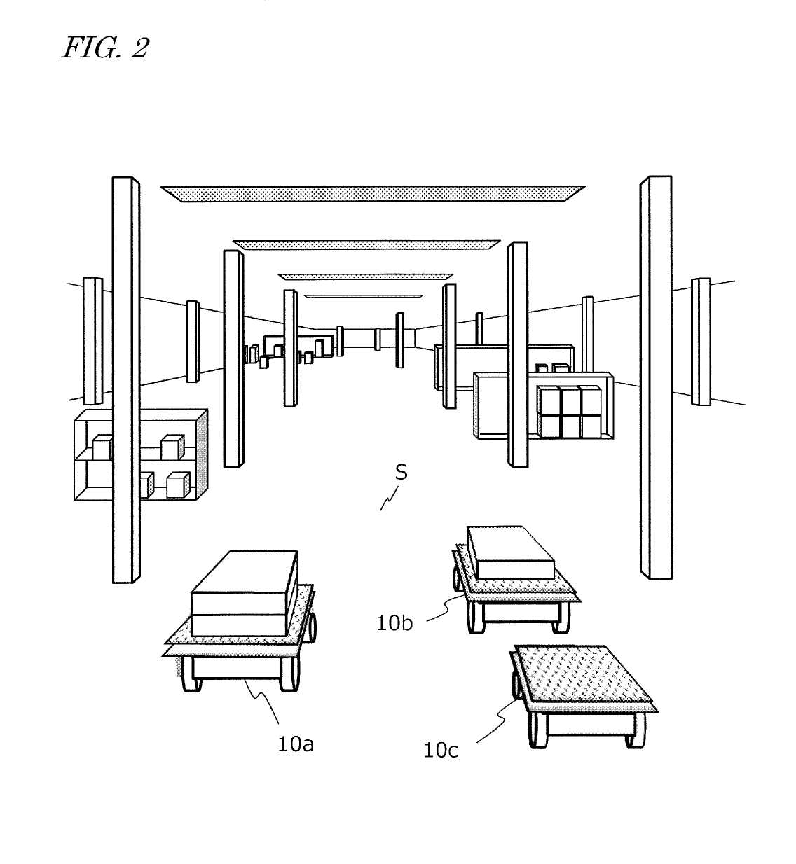

FIG. 2 shows an example of the area S in which three AGVs 10a, 10b and 10c are present. In this example, all AGVs are traveling in the depth direction in the figure. The AGVs 10a and 10b are each carrying cargo placed on the top board thereof. The AGV 10c is traveling so as to follow the AGV 10b that is traveling ahead. While reference numerals 10a, 10b and 10c are attached to the AGVs in FIG. 2 for convenience of explanation, each of these AGVs will be referred to as “the AGV 10” in the following description.

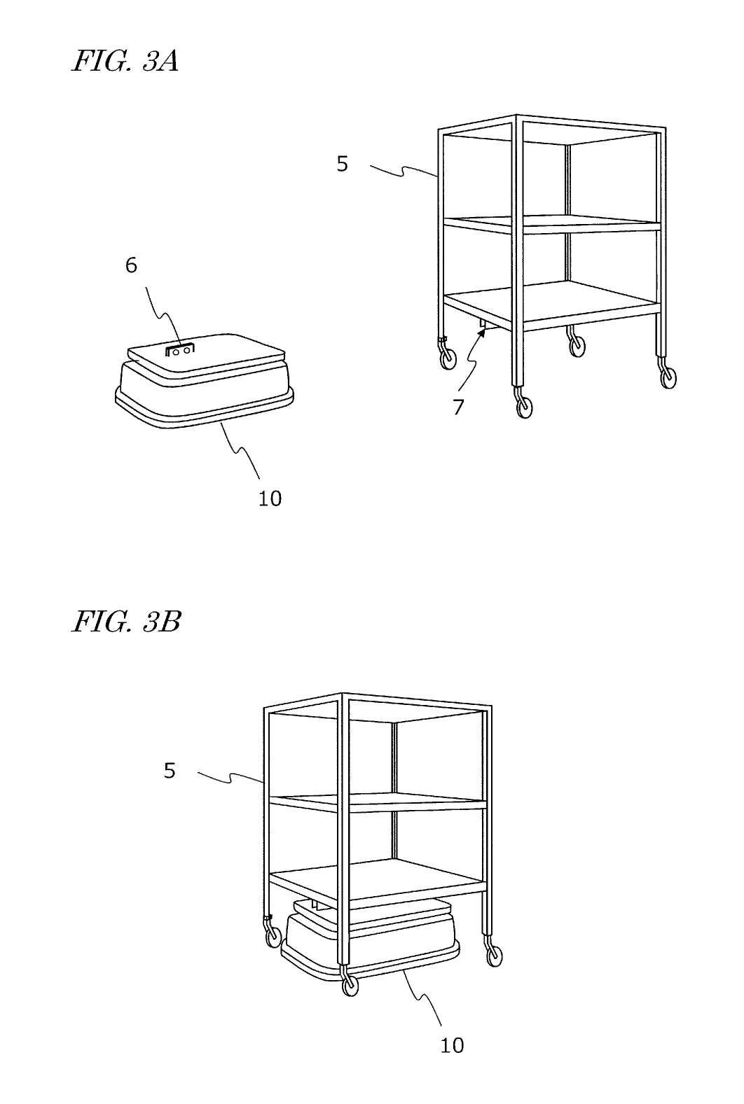

Other than by the method of carrying cargo placed on its top board, the AGV 10 may also carry cargo by using a trailer that is connected to itself. FIG. 3A shows the AGV 10 and a trailer 5 before being connected together. Each leg of the trailer 5 has a caster. The AGV 10 is mechanically connected to the trailer 5. FIG. 3B shows the AGV 10 and the trailer 5 having been connected together. When the AGV 10 travels, the trailer 5 is dragged by the AGV 10. The AGV 10 can carry the cargo placed on the trailer 5 by dragging the trailer 5.

The method of connecting the AGV 10 to the trailer 5 may be arbitrary; an example is described herein. A plate 6 is fixed to the top board of the AGV 10. The trailer 5 has a guide 7 with a slit. The AGV 10 approaches the trailer 5, and inserts the plate 6 into the slit of the guide 7. When the insertion is completed, the AGV 10 passes an electromagnetic locking pin (not shown) through the plate 6 and the guide 7, and engages electromagnetic locking. As a result, the AGV 10 and the trailer 5 are physically connected together.

FIG. 1 is referenced again. Each AGV 10 and the terminal device 20 may be connected e.g. in a one-to-one relationship to perform communications compliant with the Bluetooth standards (registered trademark) therebetween. Each AGV 10 and the terminal device 20 can also perform communications compliant with Wi-Fi (registered trademark) standards by using one or more access points 2. The plurality of access points 2 is mutually connected via, for example, a switching hub 3. Two access points 2a and 2b are shown in FIG. 1. The AGV 10 is wirelessly connected to the access point 2a. The terminal device 20 is wirelessly connected to the access point 2b. Any data transmitted by the AGV 10 is received by the access point 2a, transferred to the access point 2b via the switching hub 3, and transmitted from the access point 2b to the terminal device 20. Furthermore, any data transmitted by the terminal device 20 is received by the access point 2b, transferred to the access point 2a via the switching hub 3, and transmitted from the access point 2a to the AGV 10. Thus, bidirectional communications are achieved between the AGV 10 and the terminal device 20. The plurality of access points are also connected to the navigation management device 50 via the switching hub 3. Consequently, bidirectional communications are also achieved between the navigation management device 50 and each AGV 10.

(2) Environment Map Generation

A map in the area S is generated in order to allow the AGV 10 to travel while estimating its own position. The AGV 10 includes a localization device and a laser range finder. The AGV 10 can gene rate α map by using the output of the laser range finder.

The AGV 10 can transition to a data acquisition mode in response to the user's manipulation. In the data acquisition mode, the AGV 10 starts acquisition of sensor data by using the laser range finder. The laser range finder periodically scans the area S by emitting, for example, an infrared or visible light laser beam, around itself. The laser beam is reflected, for example, by the surface of a structure, such as a wall or a pillar, or the surface of an object placed on the floor. The laser range finder receives the reflected light of the laser beam, calculates a distance to each reflection point, and outputs data of the measurement results indicating the position of each reflection point. The position of each reflection point reflects the direction of the arrival and the distance of the reflected light. The data of measurement results may be referred to as “measurement data” or “sensor data” in some cases.

The localization device stores the sensor data in a storage device. When the acquisition of the sensor data in the area S is completed, the sensor data stored in the storage device is transmitted to an external device. The external device may be, for example, a computer which has a signal processor and in which a map generation program is installed.

The signal processor of the external device allows the sensor data acquired in respective scanning operations to be overlaid upon one another. The signal processor repeatedly performs the overlaying processing, whereby the map of the area S can be generated. The external device transmits the generated map data to the AGV 10. The AGV 10 stores the generated map data in its internal storage device. The external device may be the navigation management device 50, or may be another device.

Instead of an external device, the AGV 10 may itself generate the map. Instead of the signal processor of the above-mentioned external device, a circuit, such as the microcontroller unit (MCU) in the AGV 10, may perform the above processing. In the case where the AGV 10 generates the map, the stored sensor data does not need to be transmitted to the external device. It is generally assumed that the sensor data is large in data volume. Absence of a need to transmit sensor data to the external device can prevent communication lines from becoming occupied.

The movement inside the area S which is performed in order to acquire the sensor data can be attained by causing the AGV 10 to travel according to the user's manipulation. For example, the AGV 10 wirelessly receives traveling instructions indicating respective movements in the front/rear/right/left directions from the user, via the terminal device 20. According to the traveling instructions, the AGV 10 travels in the right-left and front-rear directions inside the area S, thereby generating the map. In the case where the AGV 10 is connected by wire to a control terminal, such as a joystick, the AGV 10 may follow the control signals from the control terminal in traveling in the front/rear/right/left directions inside the area S, thereby generating the map. It may also be possible for the sensor data to be acquired by a person who pushes along a measurement cart having a laser range finder, while walking.

Although a plurality of AGVs 10 are illustrated in FIGS. 1 and 2, there may only be one AGV 10. In the case where a plurality of AGVs 10 are present, the user 1 may use the terminal device 20 to select one of the plurality of registered AGVs 10, and allow the selected AGV 10 to generate the map of the area S.

After the map is generated, each AGV 10 can perform automated travel while estimating its own position by using the map. The processing for estimating the AGV's own position will be described later.

(3) Configuration of the AGV

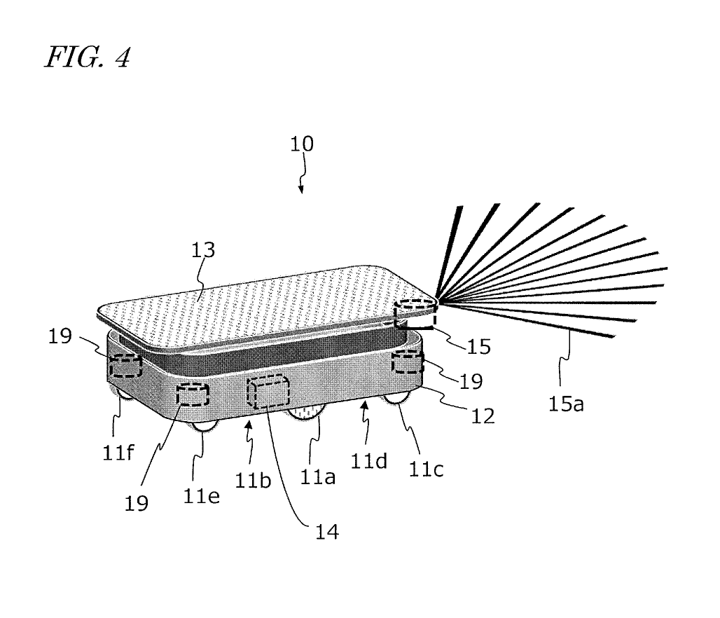

FIG. 4 is a view showing an external appearance of an exemplary AGV 10 according to the present embodiment.

The AGV 10 includes two drive wheels 11a and 11b, four casters 11c, 11d, 11 e and 11f, a frame 12, a carrying table 13, a travel control device 14 and a laser range finder 15. The two drive wheels 11a and 11b are provided on the right side and the left side of the AGV 10, respectively. The four casters 11c, 11d, 11 e and 11f are disposed at the four corners of the AGV 10. The AGV 10 also has a plurality of motors connected to the two drive wheels 11a and 11b, although the motors are not shown in FIG. 4. FIG. 4 shows the drive wheel 11a and the two casters 11c and 11e positioned on the right side of the AGV 10, and the caster 11f positioned at the left rear portion of the AGV 10. The left drive wheel 11b on the left side and the caster 11d at the left front portion are not shown clearly in FIG. 4 because they are obscured behind the frame 12. The four casters 11c, 11d, 11 e and 11f can swivel freely. In the following description, the drive wheel 11a and the drive wheel 11b may also be referred to as the wheel 11a and the wheel 11b, respectively.

The AGV 10 further includes at least one obstacle sensor 19 to detect obstacles. In the example shown in FIG. 4, four obstacle sensors 19 are provided at the four corners of the frame 12, respectively. The number and arrangement of the obstacle sensors 19 may be different from those in the example shown in FIG. 4. The obstacle sensor 19 may be a device capable of performing ranging, such as an infrared sensor, an ultrasonic sensor, or a stereo camera. In the case where the obstacle sensor 19 is an infrared sensor, the sensor can detect an obstacle that is present within a certain distance by emitting infrared rays, for example, at every certain period of time, and by measuring the time until the infrared rays reflected by the obstacle are returned. When an obstacle on a path is detected on the basis of a signal output from at least one of the obstacle sensors 19, the AGV 10 may perform an operation of avoiding the obstacle.

The travel control device 14 is a device for controlling the operation of the AGV 10. The travel control device 14 mainly includes integrated circuits including an MCU (described later), electronic parts, and a circuit board on which these integrated circuits and electronic parts are mounted. The travel control device 14 performs data transmission/reception with the above-mentioned terminal device 20 and also performs preprocessing operations.

The laser range finder 15 is an optical instrument that emits, for example, an infrared or visible light laser beam 15a, and detects reflected light of the laser beam 15a to measure a distance to the reflection point. In this embodiment, the laser range finder 15 of the AGV 10 emits a pulsed laser beam 15a in an area spanning an angle range of 135 degrees to the right and left (for a total of 270 degrees) of e.g. the front face of the AGV 10, while changing the direction of the laser beam 15a by every 0.25 degrees, and detects the reflected light of the laser beam 15a. This provides data of distance to the reflection point in directions determined by a total of 1081 steps of angle in every 0.25 degrees. In this embodiment, the scanning performed by the laser range finder 15 in the area therearound is performed substantially in parallel with the floor surface, that is, in a planar (two-dimensional) manner. Instead, the laser range finder 15 may perform scanning in the height direction.

From the position and attitude (orientation) of the AGV 10 and the scanning results of the laser range finder 15, the AGV 10 can gene rate α map of the area S. The structures, such as the walls and pillars, and the arrangement of the objects placed on the floor around the AGV 10 may be incorporated into the map. The data of the map is stored to the storage device in the AGV 10.

Generally speaking, the position and attitude of a vehicle are referred to as a pose. The position and attitude of a vehicle in a two-dimensional plane may be represented by position coordinates (x, y) in an XY Cartesian coordinate system and an angle θ with respect to the X-axis. The position and the attitude, i.e., pose (x, y, θ), of the AGV 10 may be simply referred to as “position” in the following description.

The position of a reflection point as viewed from the position at which the laser beam 15a is emitted can be expressed by using polar coordinates that are defined in terms of angle and distance. In this embodiment, the laser range finder 15 outputs sensor data that is expressed in polar coordinates. However, the laser range finder 15 may convert a position that is expressed in polar coordinates into a position expressed in Cartesian coordinates, and may output the converted position data.

Since the structure and operation principles a laser range finder are well-known, any more detailed description thereof will be omitted in the present specification. Examples of objects that can be detected by the laser range finder 15 include humans, cargo, shelves, and walls.

The laser range finder 15 is an example of an external sensor that acquires sensor data by sensing the area therearound. Other examples of such external sensors include image sensors and ultrasonic sensors.

The travel control device 14 can estimate the current position of the device itself by comparing the measurement results of the laser range finder 15 with the map data stored in itself. The map data stored in the device may have been generated by another AGV 10.

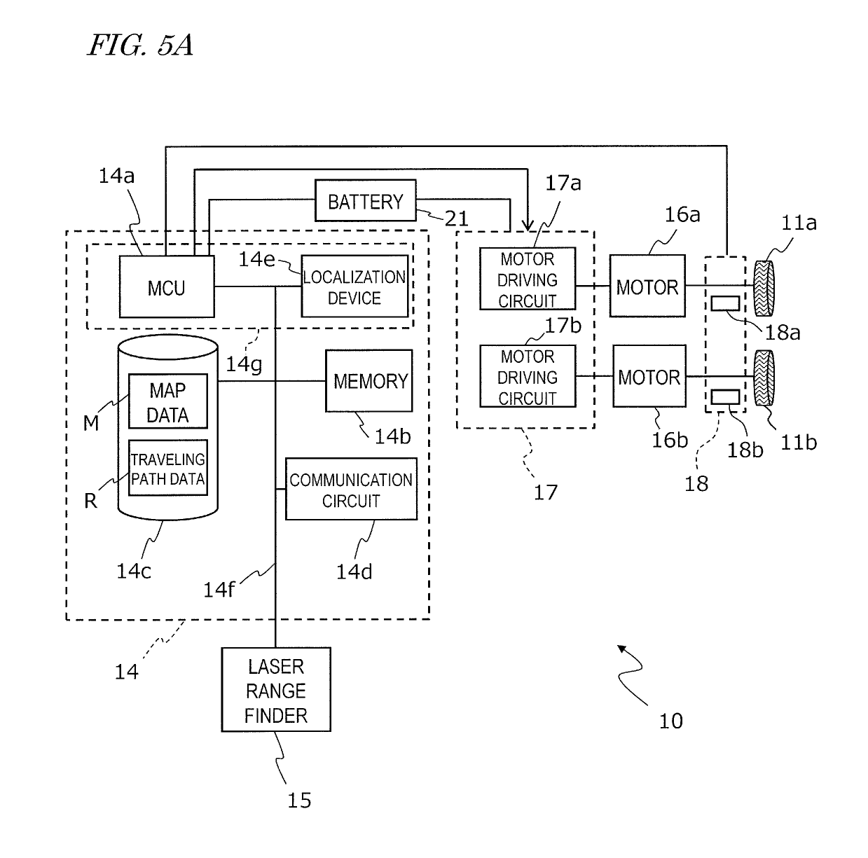

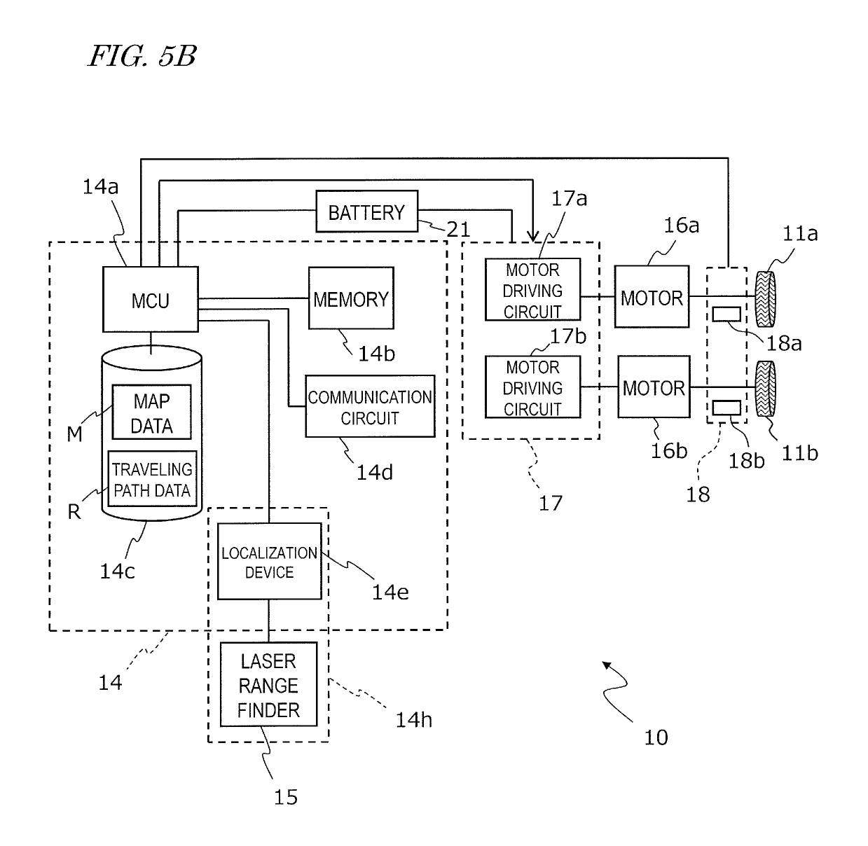

FIG. 5A shows a first example of the hardware construction of the AGV 10. FIG. 5A also shows a specific construction of the travel control device 14.

The AGV 10 includes the travel control device 14, the laser range finder 15, two motors 16a and 16b, a driving device 17, the wheels 11a and 11b, two rotary encoders 18a and 18b, and a battery 21.

The travel control device 14 includes an MCU 14a, a memory 14b, a storage device 14c, a communication circuit 14d, and a localization device 14e. The MCU 14a, the memory 14b, the storage device 14c, the communication circuit 14d, and the localization device 14e are connected via a communication bus 14f, so as to be capable of exchanging data with one another. The laser range finder 15 is also connected to the communication bus 14f via a communication interface (not shown). The laser range finder 15 transmits measurement data, that is, measurement results, to the MCU 14a, the localization device 14e and/or the memory 14b.

The MCU 14a is a processor or a control circuit that performs computation for controlling the entire AGV 10 including the travel control device 14. The MCU 14a is typically a semiconductor integrated circuit. The MCU 14a transmits a PWM (Pulse Width Modulation) signal serving as a control signal to the driving device 17, thereby controlling the driving device 17 and regulating the voltages to be applied to the motors. As a result, each of the motors 16a and 16b is rotated at a desired rotational speed.

One or more control circuits for controlling the driving of the left and right motors 16a and 16b may be provided independently of the MCU 14a. For example, the motor driving device 17 may be equipped with two MCUs for respectively controlling the motors 16a and 16b. The two MCUs may respectively perform coordinate calculations using the encoder information which is output from the encoders 18a and 18b, thereby estimating a traveled distance of the AGV 10 from a predetermined initial position. Furthermore, the two MCUs may control motor driving circuits 17a and 17b by using the encoder information.

The memory 14b is a volatile storage device for storing a computer program to be executed by the MCU 14a. The memory 14b can also be used as a work memory when the MCU 14a and the localization device 14e perform computations.

The storage device 14c is a nonvolatile semiconductor memory device. Alternatively, the storage device 14c may be a magnetic storage medium such as a hard disk, or an optical storage medium such as an optical disc. The storage device 14c may include a head device for writing and/or reading data on and/or from either one of the storage media, and a controller for the head device.

The storage device 14c stores map data M of the area S in which the AGV 10 travels and data R of one or more traveling paths. The map data M may be generated by the AGV 10 operating in a map generation mode, and stored in the storage device 14c. After the map data M is generated, the traveling path data R may be transmitted from the outside. Although this embodiment illustrates that the map data M and the traveling path data R are stored in the same storage device, i.e., the storage device 14c, the data may be stored in different storage devices.

The battery 21 is a secondary battery for storing the electric energy to be used by the driving device 17. Any arbitrarily storage battery, e.g., a lithium ion battery, a nickel cadmium battery or a lead-acid battery, can be used as the battery 21. The battery 21 is connected to the driving device 17 and the MCU 14a. The MCU 14a controls the charging/discharging of the battery 21.

In this embodiment, the battery 21 is used as an electrical storage device. An electrical storage capacitor may be used instead of the battery 21. For example, a capacitor, e.g., a lithium ion capacitor or an electric double layer capacitor, can be used as the electrical storage device.

An example of the traveling path data R will be described below.

If the terminal device 20 is a tablet computer, the AGV 10 may receive the traveling path data R, which indicates a traveling path, from the tablet computer. The traveling path data R may include marker data indicating the positions of a plurality of markers. The “markers” indicate the positions (“passing points”) that are passed by the traveling AGV 10. The traveling path data R includes at least the position information of a start marker indicating a traveling start position and an end marker indicating a traveling end position. The traveling path data R may further include the position information of markers at one or more intermediate passing points. If the traveling path includes one or more intermediate passing points, the path which spans from the start marker to the end marker while sequentially passing through the passing points is defined as a traveling path. The data of each marker may include not only coordinate data of the marker but also data of the orientation (or angle) and the travelling speed of the AGV 10 until the AGV 10 reaches to the next marker. The AGV 10 may temporarily stop at the position of each marker, perform localization, and give a notification to the terminal device 20; in this case the data of each marker may include data of the acceleration time required until reaching the traveling speed and/or data of the deceleration time required until the vehicle traveling at that traveling speed stops at the position of the next marker.

Instead of the terminal device 20, the navigation management device 50 (e.g., a PC or a server computer) may control the movement of the AGV 10. In that case, each time the AGV 10 reaches a marker, the navigation management device 50 may instruct the AGV 10 to move to the next marker. For example, the AGV 10 receives coordinate data of the next destination position, or data of the distance and the angle to proceed to the destination position, as the traveling path data R indicating the traveling path.

The AGV 10 may travel along the stored traveling path while estimating its own position using the generated map and the sensor data acquired during travel from the laser range finder 15.

The communication circuit 14d may be a wireless communication circuit configured to perform wireless communications compliant with, for example, the Bluetooth (registered trademark) standards and/or the Wi-Fi (registered trademark) standards. Either of such standards includes wireless communication standards in which a 2.4 GHz frequency band is used. For example, under the mode in which the AGV 10 is made to travel in order to gene rate α map, the communication circuit 14d performs wireless communications compliant with the Bluetooth standards and performs one-to-one communications with the terminal device 20.

The localization device 14e performs map generation processing, and localization processing during travel. The localization device 14e generates a map of the area S on the basis of the position and attitude of the AGV 10 and the scanning results of the laser range finder 15. While the vehicle is traveling, the localization device 14e receives the sensor data from the laser range finder 15 and reads the map data M stored in the storage device 14c. The localization device 14e identifies the AGV's position (x, y, θ) on the map data M by matching the local map data (or sensor data) generated from the scanning results of the laser range finder 15 against wider-range map data M. The localization device 14e generates “reliability” data indicating the degree of coincidence of the local map data with the map data M. The respective data of the AGV's position (x, y, θ) and reliability can be transmitted from the AGV 10 to the terminal device 20 or the navigation management device 50. The terminal device 20 or the navigation management device 50 may receive the respective data of the AGV's position (x, y, θ) and the reliability and may display the data on a display that is built therein or connected thereto.

Although the MCU 14a and the localization device 14e are illustrated as separate components in this embodiment, this is just an example. It may be possible to use a single chip circuit or a single semiconductor integrated circuit in which the operation of the MCU 14a and the operation of the localization device 14e can be performed independently. FIG. 5A shows a chip circuit 14g including the MCU 14a and the localization device 14e. In the following description, an example in which the MCU 14a and the localization device 14e are provided separately and independently of each other will be described.

The two motors 16a and 16b are attached to the two wheels 11a and 11b, respectively, in order to rotate the respective wheels. In other words, the two wheels 11a and 11b are both drive wheels. In this embodiment, the motors 16a and 16b drive the right wheel and the left wheel of the AGV 10, respectively.

The AGV 10 further includes an encoder unit 18 for measuring rotation positions and rotational speeds of the wheels 11a and 11 b. The encoder unit 18 includes the first rotary encoder 18a and the second rotary encoder 18b. The first rotary encoder 18a measures rotation at a position in the power transmission mechanism spanning from the motor 16a to the wheel 11a. The second rotary encoder 18b measures rotation at a position in the power transmission mechanism spanning from the motor 16b to the wheel 11b. The encoder unit 18 transmits the signals acquired by the rotary encoders 18a and 18b to the MCU 14a. The MCU 14a may control the movement of the AGV 10 by using not only the signal received from the localization device 14e but also the signal received from the encoder unit 18.

The driving device 17 has motor driving circuits 17a and 17b for regulating the voltages to be applied to the two motors 16a and 16b, respectively. Each of the motor driving circuits 17a and 17b may include an inverter circuit. The motor driving circuits 17a and 17b may turn ON or OFF the currents flowing in the respective motors in response to PWM signals transmitted from the MCU 14a or the MCU in the motor driving circuit 17a, thereby regulating the voltages to be applied to the motors.

FIG. 5B shows a second example of the hardware construction of the AGV 10. The second example hardware construction differs from the first example hardware construction (FIG. 5A) in that a laser positioning system 14h is provided and that the MCU 14a and each of the other components are connected in a one-to-one relationship.

The laser positioning system 14h includes the localization device 14e and the laser range finder 15. The localization device 14e and the laser range finder 15 are connected together via, for example, an Ethernet (registered trademark) cable. The operations of the localization device 14e and the laser range finder 15 are as described above. The laser positioning system 14h outputs information indicating the pose (x, y, θ) of the AGV 10 to the MCU 14a.

The MCU 14a has various general-purpose I/O interfaces or general-purpose input/output ports (not shown). The MCU 14a is directly connected to other components inside the travel control device 14, such as the communication circuit 14d and the laser positioning system 14h, via the general-purpose input/output ports.

The construction other than those described above with respect to FIG. 5B is identical to the construction shown in FIG. 5A. Hence, the description of any such common construction is omitted.

The AGV 10 according to an embodiment of the present disclosure may include a safety sensor, such as a bumper switch (not shown). The AGV 10 may also include an inertial measurement device, such as a gyro sensor. The traveled distance and the change amount (or angle) of the attitude of the AGV 10 may be estimated by using measurement data obtained by internal sensors, such as the rotary encoders 18a and 18b or the inertial measurement device. Such estimated values of distance and angle are referred to as odometry data or odometry information. Odometry data may serve to compliment the position and attitude data obtained by the localization device 14e. The odometry data may be used when the reliability of the estimated values of the position and attitude obtained by the localization device 14e is low, or when a map switching operation is performed.

(4) Map Data

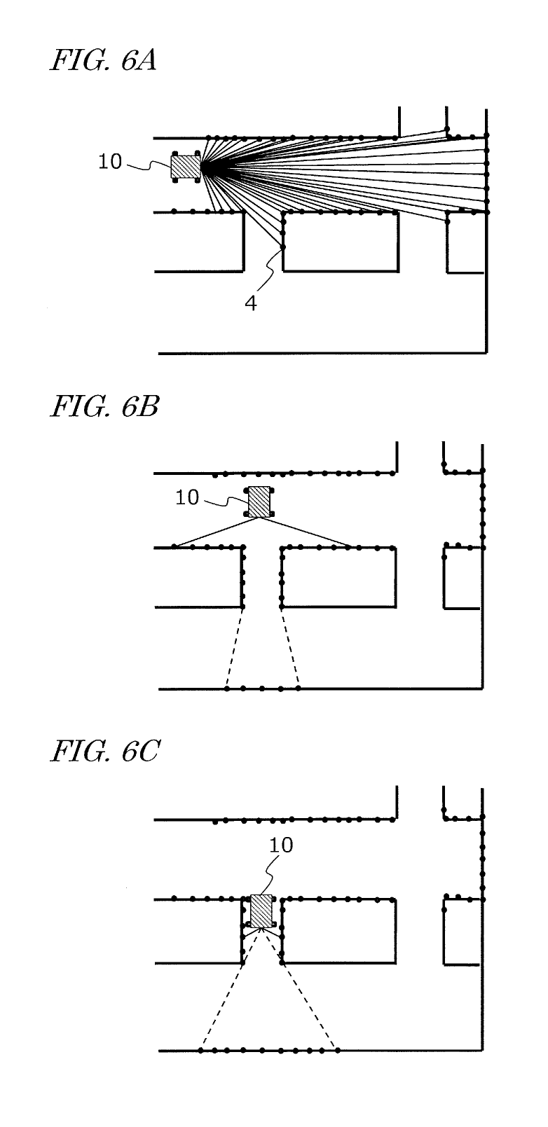

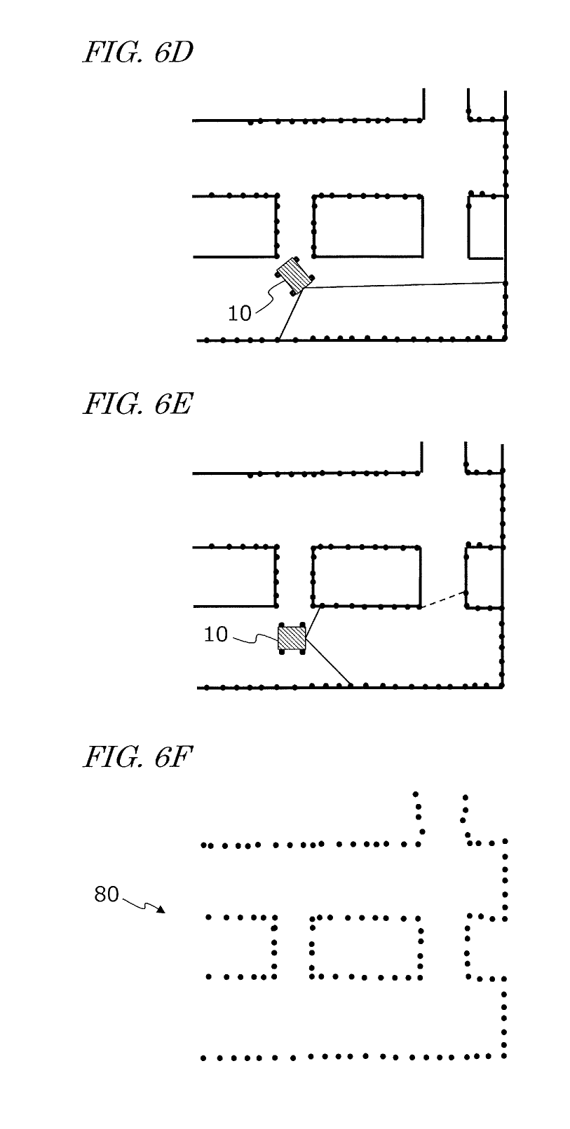

FIGS. 6A to 6F schematically illustrate the AGV 10 moving while acquiring sensor data. The user 1 may manually move the AGV 10 by manipulating the terminal device 20. Alternatively, the sensor data may be acquired by placing a unit having the travel control device 14 shown in FIGS. 5A and 5B, or the AGV 10 itself, onto a cart, and by pushing or pulling the cart with the hand of the user 1.

FIG. 6A illustrates the AGV 10 scanning the area around the vehicle using the laser range finder 15. A laser beam is emitted at every predetermined step angle, and scanning is performed. The scanning range shown in the figure is only a schematic example, which differs from the above-mentioned total scanning range of 270 degrees.

In each of FIGS. 6A to 6F, positions of the reflection points of the laser beam are shown schematically with a plurality of black points 4, each represented by a sign “•”. Laser beam scanning is performed in a short cycle while the position and attitude of the laser range finder 15 are being changed. Therefore, the number of actual reflection points is far greater than the number of reflection points 4 shown in the figures. The localization device 14e stores data of the positions of the black points 4 obtained by the travel to e.g. the memory 14b. As scanning is continuously performed while the AGV 10 is traveling, map data is gradually completed. For simplicity, FIGS. 6B to 6E only depict the scanning ranges. The scanning ranges shown are also exemplary, and differ from the above-mentioned example of 270 degrees in total.

The MCU 14a in the AGV 10 or an external computer may obtain a necessary amount of sensor data for map generation, and then gene rate α map based on the sensor data. Alternatively, the traveling AGV 10 may gene rate α map in real time, on the basis of the acquired sensor data.

FIG. 6F schematically shows a part of a completed map 80. In the map shown in FIG. 6F, free space is partitioned by point clouds corresponding to groups of reflection points of the laser beam. Another example of a map may be an occupancy grid map in which the area occupied by an object is distinguished, in grid units, from the rest of free space. The localization device 14e stores data of the map (i.e., the map data M) to the memory 14b or the storage device 14c. The number or density of black points illustrated in the figure is only an example.

The map data obtained as described above may be shared among a plurality of AGVs 10.

A typical example of an algorithm for the AGV 10 to estimate its own position on the basis of map data is ICP (Iterative Closest Point) matching. As described above, the AGV's position (x, y, θ) on the map data M may be estimated by matching the local map data (sensor data) generated from the scanning results of the laser range finder 15 against wider-range map data M.

If the area in which the AGV 10 travels is wide, the amount of the map data M will be large. This may cause inconveniences, e.g., map generation time may increase or a large amount of time may be required for localization. To avoid such inconveniences, the map data M may be generated and recorded in a manner of being divided into a plurality of partial map data segments.

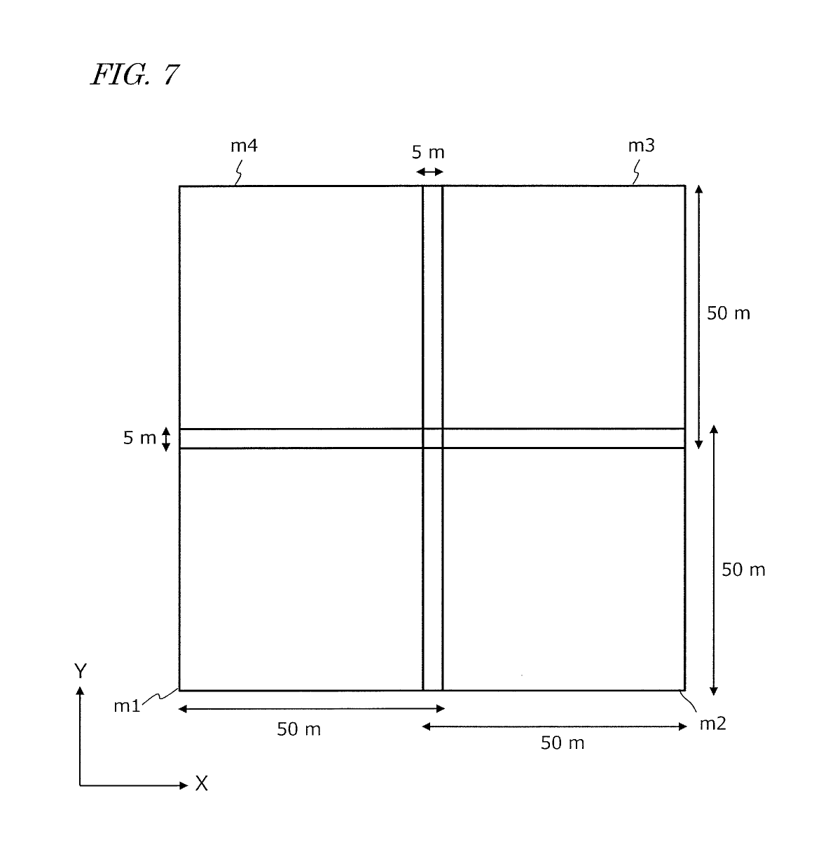

FIG. 7 shows an example in which one floor of a factory is entirely covered by a combination of four partial map data segments m1, m2, m3 and m4. In this example, one partial map data segment covers an area of 50 m×50 m. At each boundary between two adjacent partial map data segments along the X-direction or the Y-direction, a rectangular overlapping area having a width of 5 m is provided. This overlapping area is referred to as a “map switching area”. Once the AGV 10 that travels while referring to one partial map segment reaches a map switching area, the traveling mode of the vehicle is switched to a different mode in which the vehicle refers to another, adjacent partial map data segment. The number of partial map data segments is not limited to four, and the number may be set in accordance with the geometric area of the floor which is traveled by the AGV 10 and the performance of the computer that carries out map generation and localization. The size of each partial map data segment and the width of each overlapping area are not limited to the above-mentioned examples, but may be set arbitrarily.

(5) An Example Construction of the Navigation Management Device

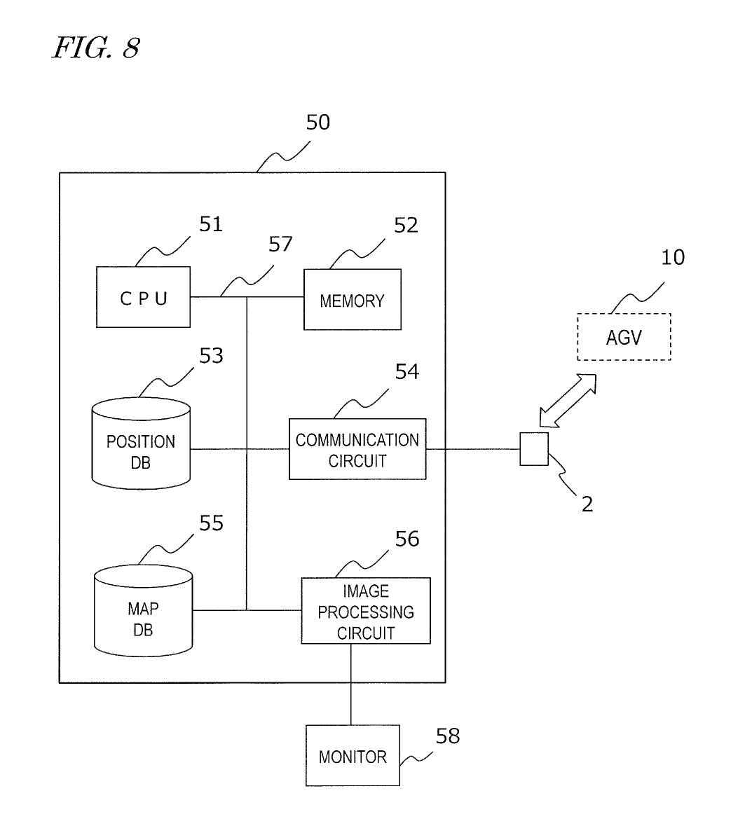

FIG. 8 shows an example hardware construction of the navigation management device 50. The navigation management device 50 includes a CPU 51, a memory 52, a position database (position DB) 53, a communication circuit 54, a map database (map DB) 55, and an image processing circuit 56.

The CPU 51, the memory 52, the position DB 53, the communication circuit 54, the map DB 55, and the image processing circuit 56 are connected via a communication bus 57, so as to be capable of exchanging data with one another.

The CPU 51 is a signal processing circuit (or a computer) configured to control the operation of the navigation management device 50. The CPU 51 is typically a semiconductor integrated circuit.

The memory 52 is a volatile storage device that stores a computer program to be executed by the CPU 51. The memory 52 may also be used as a work memory when the CPU 51 performs computations.

The position DB 53 stores position data indicating respective positions that may become the destinations of the respective AGVs 10. The position data may be represented by coordinates that are virtually designated inside a factory by an administrator. The position data may be determined by the administrator.

The communication circuit 54 performs wired communications compliant with, for example, the Ethernet (registered trademark) standards. The communication circuit 54 is connected to the access points 2 (see FIG. 1) by wire and can communicate with the AGV 10 via the access points 2. Via the bus 57, the communication circuit 54 may receive data to be transmitted to the AGV 10 from the CPU 51. The communication circuit 54 may also transmit data (or notification) that is received from the AGV 10 to the CPU 51 and/or the memory 52, via the bus 57.

The map DB 55 stores data of the map of a factory or warehouse, etc. in which the AGV 10 travels. The map may be identical to the map 80 (shown in FIG. 6F), or may be different from the map 80. The format of the map data does not matter so long as the map has one-to-one correspondence with respect to the positions of the respective AGVs 10. For example, the map to be stored in the map DB 55 may have been generated by CAD (Computer-Aided Design).

The position DB 53 and the map DB 55 may be stored on a nonvolatile semiconductor memory. Alternatively, these DBs may be stored on a magnetic storage medium such as a hard disk or on an optical storage medium such as an optical disc.

The image processing circuit 56 is configured to generate image data to be displayed on a monitor 58. The image processing circuit 56 operates when the administrator manipulates the navigation management device 50. Any more detailed description thereof will be omitted for the purpose of this embodiment. The monitor 58 may be integrated with the navigation management device 50. The processing by the image processing circuit 56 may be performed by the CPU 51 instead.

(6) Operation of the Navigation Management Device

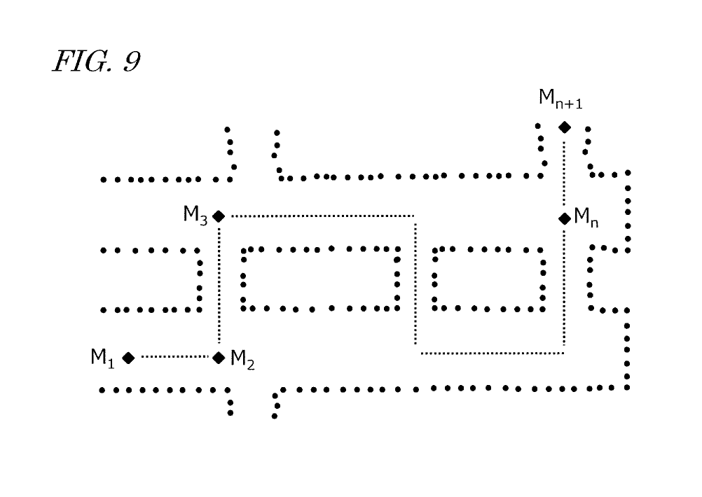

An outline of the operation of the navigation management device 50 will be described with reference to FIG. 9. FIG. 9 is a schematic view showing an exemplary traveling path for the AGV 10 that is determined by the navigation management device 50.

The operations of the AGV 10 and the navigation management device 50 will be described in outline below. In the following description, an example is described in which an AGV 10 that is currently located at a point (marker) M₁ passes several positions, and travels to a marker Mₙ₊₁ (n: a positive integer of 1 or more), i.e., the final destination. The position DB 53 stores coordinate data indicating respective positions, such as a marker M₂ to be passed next to the marker M₁ and a marker M₃ to be passed next to the marker M₂, etc.

The CPU 51 in the navigation management device 50 reads the coordinate data of the marker M₂ by referring to the position DB and generates a traveling instruction for moving the AGV 10 toward the marker M₂. The communication circuit 54 transmits the traveling instruction to the AGV 10 via the access points 2.

From the AGV 10, the CPU 51 periodically receives data indicating the current position and attitude of the AGV 10, via the access points 2. Thus, the navigation management device 50 can track the position of each AGV 10. Upon determining that the present position of the AGV 10 has matched the marker M₂, the CPU 51 reads the coordinate data of the marker M₃, generates a traveling instruction for moving the AGV 10 toward the marker M₃, and transmits the traveling instruction to the AGV 10. In other words, upon determining that the AGV 10 has reached a certain position, the navigation management device 50 transmits a traveling instruction for moving the AGV 10 toward the position to be passed next. As a result of this, the AGV 10 can reach the marker Mₙ₊₁, i.e., the final destination.

(7) An Example of the Operation of the AGV

Next, an example of the operation of the AGV 10 traveling repeatedly along a predetermined route will be described.

The AGV 10 according to this embodiment repeatedly travels along a predetermined route. The AGV 10 performs travel in a plurality of cycles according to instructions from an external device. The external device may be, for example, the navigation management device 50 (hereafter simply referred to as the “management device 50”) or the terminal device 20. In the following description, an example where the external device is the management device 50 will mainly be described.

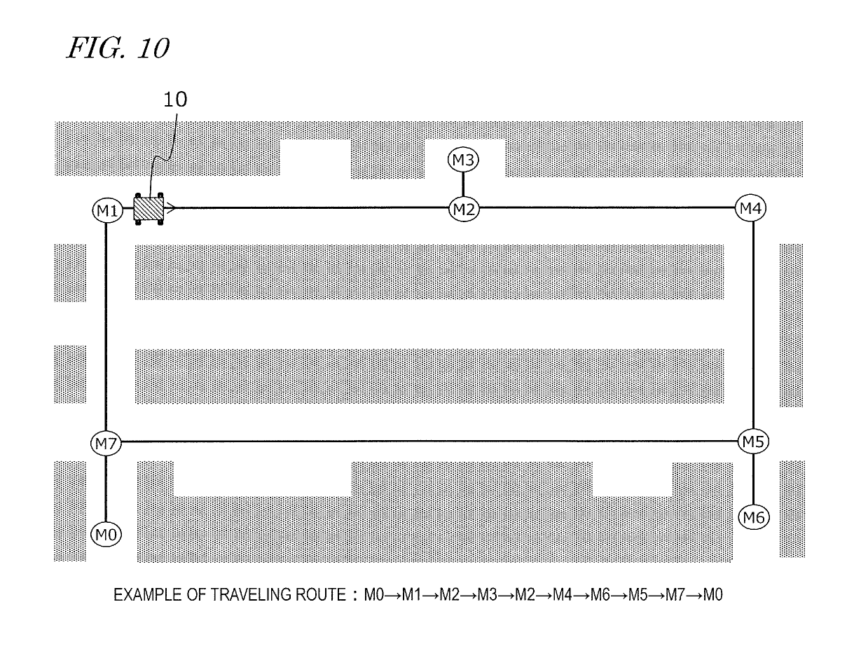

FIG. 10 is a view showing an example of a route along which the AGV 10 travels. In this example, the management device 50 sets eight markers M0 to M₇, and transmits information thereof to the AGV 10. According to instructions from the management device 50, the AGV 10 starts moving from an initial position, i.e., the marker M0, passes the markers M₁ to M₇ sequentially, and returns to the marker M0. In other words, the traveling route in this example is M0→M1→M2→M3→M2→M4→M5→M6→M5→M7→M0. At the markers M0, M3 and M6, cargo is unloaded, for example. At the other markers M1, M2, M4, M5 and M7, the AGV 10 changes the direction by approximately 90 degrees and goes to the next marker. The AGV 10 travels along such a route repeatedly, many times in a day.

In such a system, it is important to manage the remaining electric energy stored in the battery 21 (hereafter also referred to as “remaining battery power”). If a shortage of remaining battery power occurs in the middle of the travel, the vehicle cannot completely travel the predetermined route. If the remaining power of the battery 21 becomes scarce, it is necessary to move the AGV 10 to a power-supplying area where power supply equipment is installed, and charge the battery 21.

One possible method for managing the remaining power of the battery 21 may be based on the traveling time after a state of full charge, or measurement values of remaining power of the battery 21. For example, it may be possible to use a method in which a signal indicating shortage of battery power (hereafter referred to as an “alert”) is output when the traveling time after a state of full charge exceeds a predetermined time, or the remaining power of the battery 21 becomes lower than a predetermined threshold value during traveling. Such an alert may urge the user to charge the battery, or the AGV 10 may automatically start moving to the power-supplying area.

However, such a system as described above may experience these situations: an alert is issued in the middle of the travel; or the vehicle stops in the middle of the travel on the route because of a shortage of battery power. One countermeasure to such situations may be to ensure that the alert is issued sufficiently early on; in that case, however, the capacity of the battery 21 will not be fully utilized. Furthermore, since the battery 21 deteriorates gradually over the duration of use, the threshold value for allowing an alert to be issued needs to be reset periodically.

Accordingly, in this embodiment, when starting each cycle of travel, the MCU 14a in the AGV 10 compares the remaining energy of the battery 21 against a threshold value, and depending on the result of the comparison, determines whether to start the travel or issue the alert. More specifically, if the remaining energy of the battery 21 exceeds the threshold value, the MCU 14a causes the driving device 17 to start the travel of the vehicle. Conversely, if the remaining energy of the battery 21 does not exceed the threshold value, the MCU 14a causes the communication circuit 14d to transmit the alert. The threshold value is set on the basis of the energy consumed by at least one cycle of travel in the past. For example, the threshold value can be set to the amount of the energy consumed by the preceding cycle of travel, or the largest value from among the amounts of the energy consumed by the respective cycles of travel in the past. The above-mentioned method of setting the threshold value is applied to the second and subsequent cycles of travel. When starting the first cycle of travel after power activation or after system introduction, the threshold value can be set to a sufficiently large value such that one cycle of travel will presumably be completed, for example.

With such construction, the remaining battery power can be managed on the basis of the actually consumed electric energy. This makes it possible to reduce the risk that the AGV 10 may stop in the middle of travel due to shortage of remaining battery power. Furthermore, it is possible to prevent an alert from being issued even though the remaining battery power is sufficient. Moreover, it is possible to automatically update the threshold value according to a predetermined rule. Consequently, for example, even when the power consumption in one cycle has changed gradually over the duration of use of the battery 21, it is possible to automatically update the threshold value to an appropriate value.

The alert is transmitted from the communication circuit 14d to the management device 50. The alert may be transmitted to not only the management device 50 but also the terminal device 20 or other devices, such as a display (not shown). The device having received the alert may, for example, display an image or generate sound indicating that the remaining battery power is insufficient. As a result, the user or the administrator can recognize the shortage of remaining battery power and can start an action required for charging.

A more specific example of the operation of the AGV 10 described above will be described below.

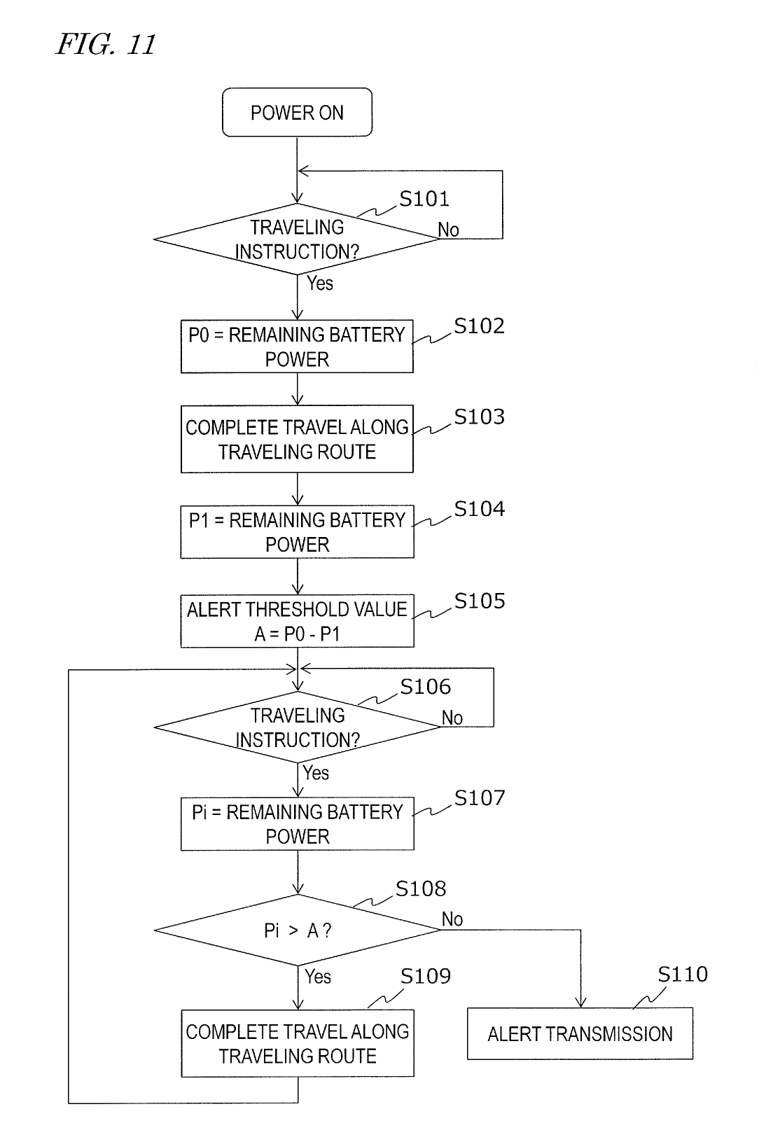

FIG. 11 is a flowchart showing a first example of the operation of the AGV 10. In this example, the AGV 10 performs travel along the same route, in a plurality of cycles. After the power is turned ON and after a first cycle of travel is completed, the MCU 14a allows a difference (referred to as the “first difference value”) between the remaining energy of the battery 21 at the start time of the travel and the remaining energy thereof at the completion time of the first cycle of travel to be set as the threshold value. In the second and subsequent cycles, when starting travel, if the remaining energy of the battery 21 is not more than the threshold value having been set, an alert is issued. This operation will be described below specially.

First, at step S101, the MCU 14a determines whether a traveling instruction has been issued. The traveling instruction is an instruction to start travel and is transmitted from e.g. an external device, such as the management device 50 or the terminal device 20. Upon receiving the traveling instruction via the communication circuit 14d, the MCU 14a starts travel of the AGV 10. In the example shown in FIG. 10, the AGV 10 starts traveling from the position of the marker M0. In this example, in the initial state, the battery 21 is in a nearly fully-charged state. A predetermined initial value is used as the threshold value (which may hereafter be referred to as the “alert threshold value”) that is referenced for determining whether the alert has been issued. In this state, the remaining energy of the battery 21 is sufficiently greater than the alert threshold value; therefore, the operation of comparing the remaining battery power in the initial state with the alert threshold value is omitted in FIG. 11.

Next, at step S102, the MCU 14a measures the remaining battery power. Measurement of the remaining battery power can be performed, for example, by measuring the voltage of the battery 21. Let the remaining battery power be P0. After that, at step S103, the AGV 10 begins traveling along the predetermined route. In this first cycle, since the remaining battery power is sufficient, the AGV 10 can completely travel the entire route. In the example shown in FIG. 10, the AGV 10 returns to the position of the marker M0, thus completing its carrying operation.

At step S104, the MCU 14a measures the remaining battery power again. Let the remaining battery power at this time be P1. At step S105, the MCU 14a sets the alert threshold value to A=P0−P1. In other words, the MCU 14a sets the alert threshold value to the value corresponding to the energy consumed by the first travel along the route.

In this state, the MCU 14a waits for a next traveling instruction. Upon receiving the next traveling instruction at step S106, the MCU 14a again measures the remaining battery power at step S107. Let the remaining battery power at this time be Pi. At step S108, the MCU 14a determines whether the remaining battery power Pi is greater than a threshold value A which was previously set. If Pi>A, the processing proceeds to step S109, where the MCU 14a causes the vehicle to complete traveling the entire route. After that, the procedure returns to step S106, and a similar operation is repeated thereafter.

If Pi≤A at step S108, it is decided that the remaining battery power is not sufficient. In this case, the processing proceeds to step S110, where the MCU 14a causes the communication circuit 14d to transmit an alert indicating that the remaining battery power is insufficient. The alert is transmitted to, for example, the management device 50. The management device 50 allows the alert to be displayed, for example, on the display. The user or the administrator having viewed the alert can recognize the shortage of battery power. At this time, the MCU 14a does not start the travel of the AGV 10, but stands by.

By the above-mentioned operation, on the basis of the energy of the battery 21 consumed in the first cycle, the AGV 10 can determine whether the remaining energy of the battery 21 is sufficient for the subsequent cycles. In the case where the travel along the same route is performed continuously, it is assumed that consumption of the battery 21 will not change very much from cycle to cycle. By causing the control circuit of the vehicle to perform the operation shown in FIG. 11, it is possible to reduce the risk that the remaining battery power may become insufficient in the middle of the travel.

In this example, the threshold value A at step S105 is set to P0-P1; however, the threshold value A may be set to another value. For example, the threshold value A may be set to a value slightly greater than the value of P0-P1 so as to allow for a margin. As an example, the threshold value A may be set to a value approximately 1.1 to 1.5 times as large as the value of P0-P1. In that case, the risk that the vehicle may stop in the middle of the travel can be further reduced.

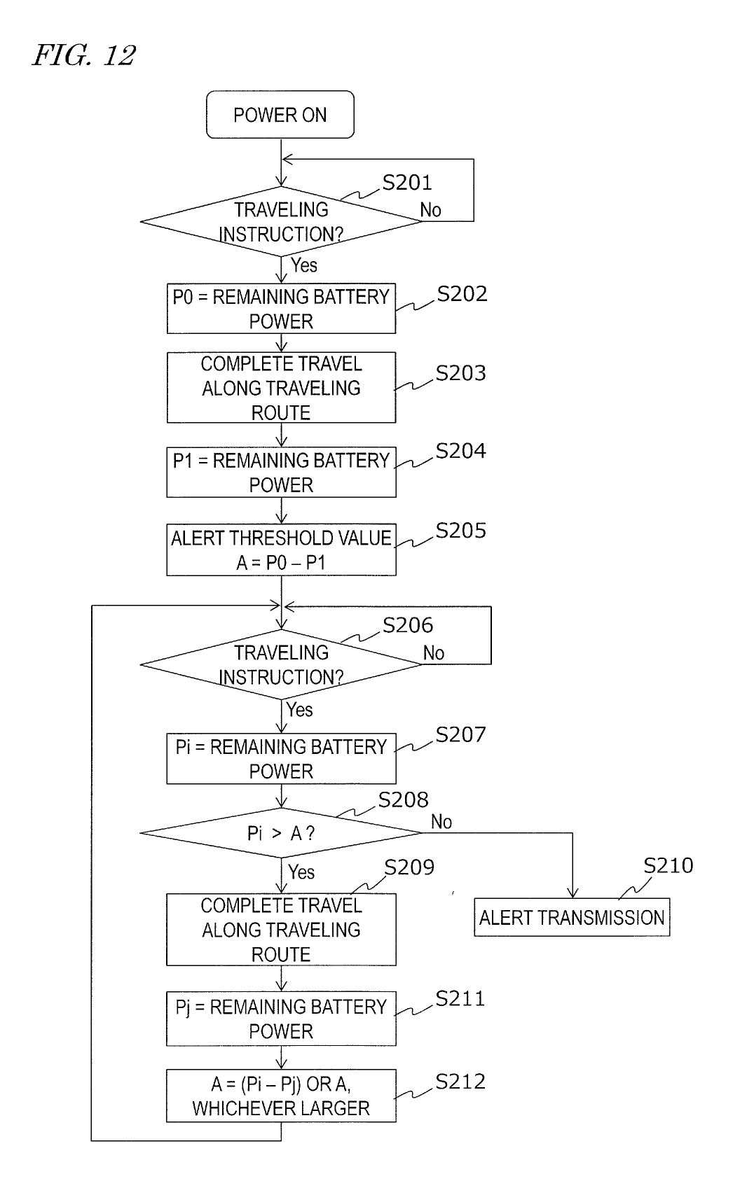

FIG. 12 is a flowchart showing a second example of the operation of the AGV 10. In this example, in addition to the operation shown in FIG. 11, the MCU 14a updates the threshold value A when specific conditions are satisfied after the second cycle of travel is completed. Since the operation from steps S201 to S210 in FIG. 12 is the same as the operation from steps S101 to S110 in FIG. 11, the description of any such operation is omitted. The operation shown in FIG. 12 differs from the operation shown in FIG. 11 with respect to the operation at steps S211 and S212. In this example, in the second and the subsequent cycles, if a difference (referred to as the “second difference value”) between the remaining energy of the battery 21 at the start time of the travel and the remaining energy thereof at the completion time of the travel is greater than the threshold value, the threshold value is updated to the second difference value. After completion of each of the second and the subsequent cycles of travel, the MCU 14a measures the remaining battery power at step S211. Let the value of the remaining battery power be Pj. At the next step S212, the MCU 14a compares (Pi−Pj) against the threshold value A. If (Pi−Pj)>A, the MCU 14a updates the threshold value A to the value of (Pi−Pj).

By the above-mentioned operation, the threshold value A to be referenced in each of the second and the subsequent cycles is set to the maximum value of the energy consumed by the respective cycles of travel having been performed so far. Thus, even when the energy consumed by each cycle of travel varies, it is possible to reduce the risk that a shortage of battery power may occur in the middle of the travel.

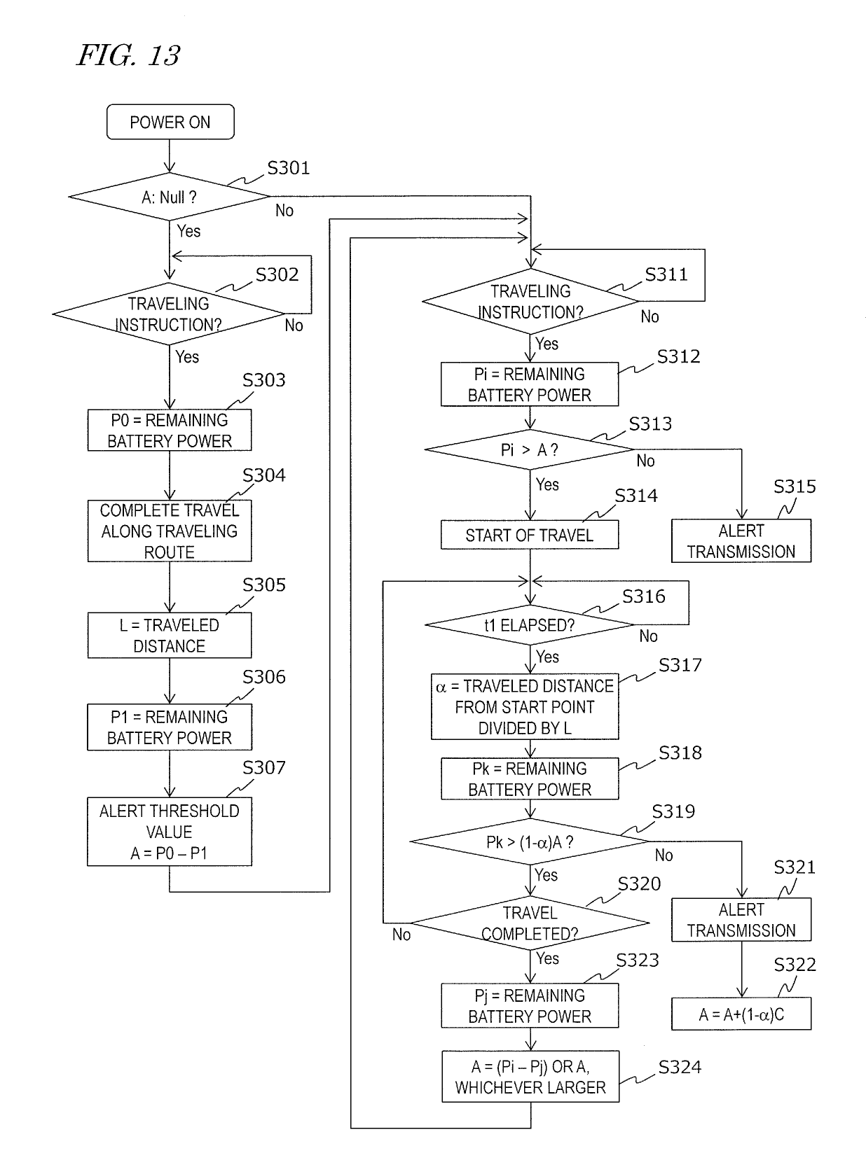

FIG. 13 is a flowchart showing a third example of the operation of the AGV 10. In this example, during each cycle of travel, the MCU 14a measures the remaining energy of the battery 21 at every predetermined time, and estimates a traveled distance from the start point on the basis of the position information estimated by the localization device 14e. After that, the MCU 14a calculates a progress rate α, i.e., the rate of the traveled distance to the total distance to be traveled in the route. When the measured remaining energy becomes equal to or less than a first value which is determined from the threshold value A and the progress rate α, the MCU 14a causes the communication circuit 14d to transmit an alert. At this time, the MCU 14a increases the threshold value A by a second value which is determined from the progress rate α. This makes it possible to reduce the risk that the remaining battery power may become insufficient in the middle of the travel.

In the example in FIG. 13, first, at step S301, the MCU 14a determines whether the threshold value A has been set. If the threshold value has not been set (i.e., Null), the operation from steps S302 to S307 is performed. If the threshold value A has been set, the operation of step S311 and the subsequent steps is performed.

At step S302, the MCU 14a determines whether a traveling instruction has been received. If a traveling instruction has been received, the processing proceeds to step S303, where the MCU 14a measures remaining battery power and sets this value as P0. At the next step S304, the MCU 14a issues a travel start instruction to the driving device 17, and the AGV 10 starts travel. When the AGV 10 has completely traveled the entire route, the MCU 14a calculates at step S305 the traveled distance in one cycle, from the history of position information output from the localization device 14e. This traveled distance is set as L. Next, at step S306, the MCU 14a sets the alert threshold value to A=P0−P1.

Next, at step S311, the MCU 14a stands by until a traveling instruction is received. When a traveling instruction is received, the MCU 14a measures the remaining battery power at that time, and sets this value as Pi at step S312. At the next step S313, the MCU 14a compares the remaining battery power Pi against the alert threshold value A. If Pi>A at this step, the MCU 14a causes the driving device 17 to operate so that the vehicle starts travel. If Pi≤A, the MCU 14a causes the communication circuit 14d to transmit an alert to the communication circuit 14d.

The MCU 14a in this example calculates the progress rate α and measures the remaining battery power at every predetermined time t1 after the start of travel, and determines whether the remaining battery power is sufficient (at step S316 to step S320). The time t1 may be set to an arbitrary time. The time t1 can be set to a value within a range between, for example, 100 msec and 10 sec. The time t1 can be set to a value longer than the cycle at which the localization device 14e outputs the position information. In an example, the time t1 is set to approximately 300 msec.

At step S316, the MCU 14a stands by until the time t1 elapses. At step S317, the MCU 14a calculates the progress rate α, i.e., the rate of the traveled distance from the start point to the total distance L to be traveled in the route. At step S318, the MCU 14a measures the remaining battery power and sets this value as Pk. At step S319, the MCU 14a compares the remaining battery power Pk against a first value (1−α)A which is determined from the threshold value A and the progress rate α. If Pk>(1−α)A, the processing proceeds to step S320, where the MCU 14a determines whether the travel is completed. If the travel is not completed, the processing returns to step S316 and the above-mentioned operation is performed again.

If Pk≤(1−α)A at step S319, the processing proceeds to step S321, where the MCU 14a causes the communication circuit 14d to transmit an alert. Furthermore, at step S322, the MCU 14a increases the threshold value A by a second value (1−α)C which is determined from the progress rate α. C is herein a predetermined constant value. C can be set, for example, to the same value as the threshold value A having been used so far. In that case, the threshold value A is updated to A+(1−α)A. In the case where the alert is transmitted, the MCU 14a issues an instruction to the driving device 17 to stop the AGV 10, or start travel of the AGV 10 toward the power-supplying area.

When the travel is completed at step S320, the processing proceeds to step S323, where the MCU 14a measures the remaining battery power again and sets this value as Pj. At the next step S324, the MCU 14a compares (Pi−Pj) against the threshold value A. If (Pi−Pj)>A, the threshold value A is updated to the value of (Pi−Pj). After that, the processing returns to step S311, and the above-mentioned operation is repeated.

As described above, in the example in FIG. 13, while the AGV 10 is traveling, the MCU 14a repeatedly evaluates the remaining battery power on the basis of the progress rate α. After that, if the MCU 14a determines that the remaining battery power is insufficient in view of the progress rate α, the MCU 14a causes the communication circuit 14d to transmit an alert. Furthermore, the MCU 14a updates the threshold value A to be used in the next and subsequent cycles to a value greater than the values having been used so far.

By the above-mentioned operations, it is possible to further reduce the risk that the vehicle may become unable to travel in the middle of each cycle of travel due to insufficient remaining power of the battery 21.

In the example shown in FIG. 13, the traveled distance from the start point is calculated on the basis of the position information output from the localization device 14e. The localization device 14e identifies the position by matching the data output from the laser range finder 15 against the map data. The MCU 14a can calculate the traveled distance according to the position information that is output at every predetermined time. Instead of using the above-mentioned method, the position and the traveled distance of the vehicle may be estimated on the basis of a signal output from an internal sensor. For example, the position and the traveled distance can be estimated by totaling signals each indicating the number of rotations of the wheels per unit time and being output from the encoder unit 18 shown in FIGS. 5A and 5B. As described above, the localization device can estimate the position of the vehicle on the basis of the signals output from the external sensor or the internal sensor. The control circuit of the vehicle can estimate the traveled distance from the start point and the progress rate on the basis of the information of the estimated position.

Next, an example of an operation will be described in which the number of cycles of travel is managed daily and the threshold value is set to an appropriate value on the basis of the daily number of cycles of travel.

The control circuit provided in the vehicle may daily record the number of cycles of travel and/or the energy consumed by each cycle of travel. The threshold value B to be referenced in the first cycle in a day may be set to a value which is proportional to the number of cycles of travel performed on the previous day, or on the day before the previous day. For example, the threshold value B may be set to a value obtained by multiplying the number of cycles by an estimated value of energy consumed in one cycle. The estimated value of energy consumed in one cycle coincides with, for example, the above-mentioned alert threshold value A. The threshold value B may also be set to a total energy consumed by all of the cycles of travel which were performed on the previous day or on the day before the previous day. Such setting of the threshold value B is particularly effective in the case where changes in daily workload are small. For example, if the vehicle undergoes on a certain day the same number of cycles as the number of cycles on the previous day, then the energy of the electrical storage device to be consumed on the day is expected to be nearly equal to the energy consumed on the previous day. Therefore, it is reasonable that a product of multiplying the number of cycles of travel performed on the previous day by the estimated value of energy consumed in one cycle, or the total energy that was consumed by all of the cycles of travel on the previous day, should be set as the threshold value B in the first cycle of the day. By the above-mentioned setting, at the start time of the travel of a day, it is possible to determine whether the amount of stored power in the electrical storage device is sufficient to complete all of the cycles of travel on that day.

It is also conceivable in some cases that the number of cycles on a certain day may be different from the number of cycles on a past day. In such cases, a value which is obtained by multiplying the ratio between the number of cycles on that day and the number of cycles on that past day, by the above-mentioned threshold value B, can be set as the threshold value in the first cycle on the day. For example, let it be assumed that n1 cycles were performed on the previous day and that n2 cycles are to be performed on the day, where n1 and n2 are mutually different integers each being 2 or more. In this case, B×(n2/n1) can be set as the alert threshold value in the first cycle on the day.

The above-mentioned operation may be performed by not only the control circuit provided in the vehicle but also by an external device, such as the management device 50. In other words, it may be possible for the external device to determine the threshold value and transmit the threshold value to each vehicle. The vehicle may refer to the threshold value received from the external device, and determine the remaining battery power.

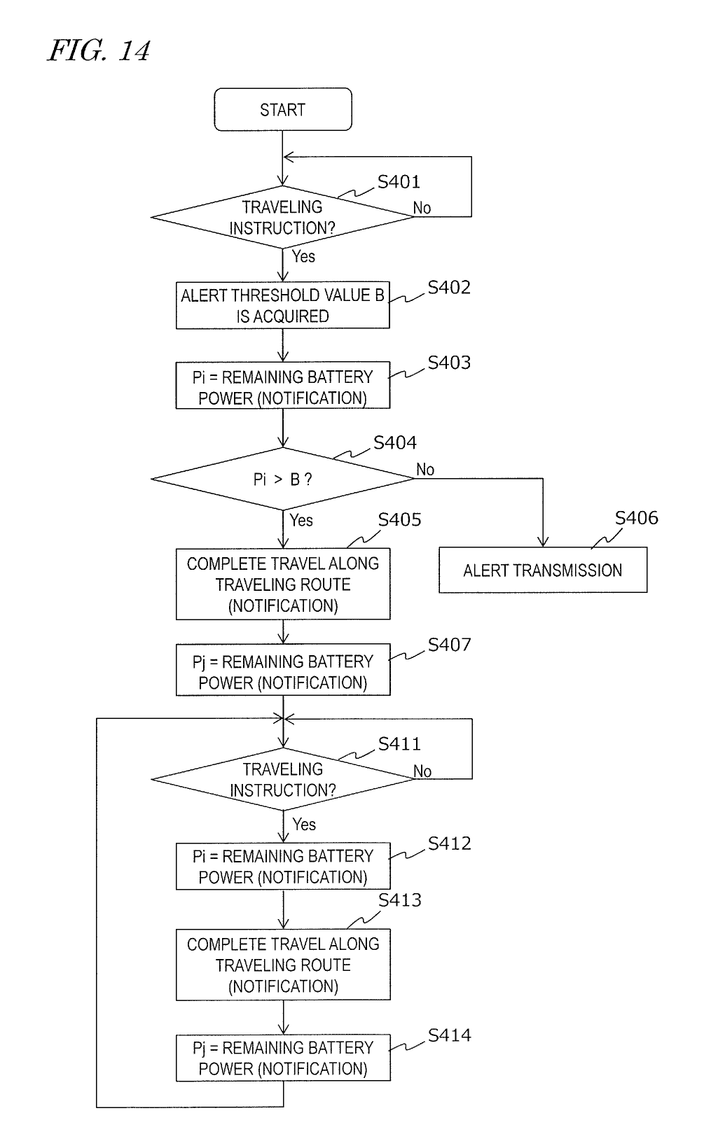

FIG. 14 is a flowchart showing a fourth example of the operation of the AGV 10. In this example, when receiving the first traveling instruction on a day, the MCU 14a provided in the AGV 10 acquires the alert threshold value B having been set by the management device 50 (at step S401 and step S402). The threshold value B can be transmitted from the management device 50 to the AGV 10 together with the traveling instruction. Alternatively, the threshold value B may have been stored in an external storage device in advance. At step S403, the MCU 14a measures the remaining battery power, and sets this value as Pi. At this time, the MCU 14a transmits the value Pi to the management device 50 via the communication circuit 14d. At step S404, the MCU 14a compares Pi against the threshold value B. If Pi≤B, the processing proceeds to step S406, where the MCU 14a transmits an alert to the management device 50 via the communication circuit 14d. If Pi>B, the processing proceeds to step S405, where the MCU 14a starts travel of the vehicle along the route. In this example, when the vehicle has completely traveled the entire route, the MCU 14a transmits a signal indicating completion of the travel to the management device 50 via the communication circuit 14d. At the next step S407, the MCU 14a measures the remaining battery power, and sets this value as Pj. The MCU 14a also transmits the value Pj to the management device 50.

In the second and subsequent cycles, the AGV 10 performs the operation described at steps S411 to S414. The operation occurring at steps S411, S412, S413 and S414 is the same as the operation at steps S401, S403, S405 and S407, respectively.

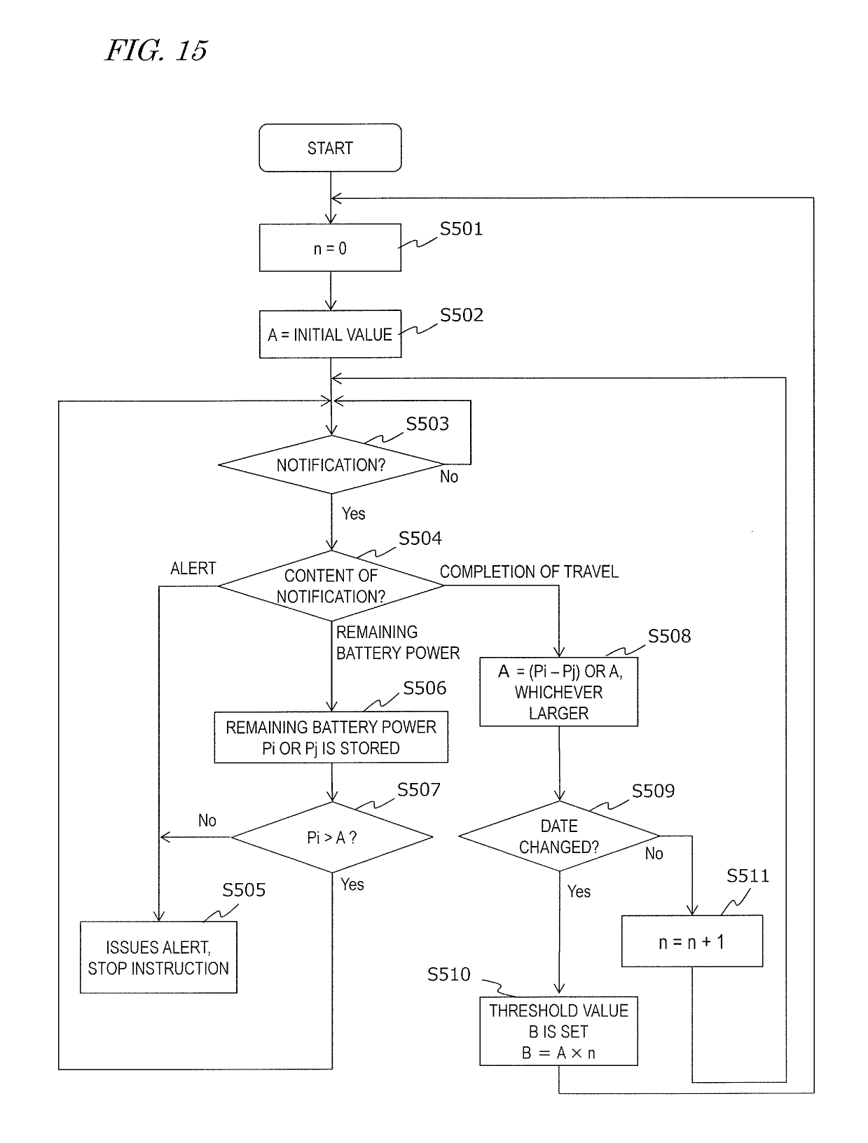

FIG. 15 is a flowchart showing the operation of the management device 50 in this example. The management device 50 in this example has a time/day management function. The management device 50 daily manages the number of times n that each AGV 10 has traveled along the designated course. Although the management device 50 also performs the operation of transmitting a traveling instruction to each AGV 10, the traveling instruction is omitted in FIG. 15.

After the start of the operation of the system, first, at step S501, the number n of times of travel is set to 0. At step S502, the estimated value A of the electric energy required for one cycle of travel is set as the initial value. In this state, the management device 50 determines the presence/absence of a notification from the AGV 10 (at step S503). If there is a notification, the management device 50 performs an operation in accordance with the content of the notification (at step S504).

In the case that the notification indicates an alert, the management device 50 outputs the alert to a device, such as a display or a speaker, that is built in or connected to the management device 50 itself (at step S505). Furthermore, the management device 50 transmits a stop instruction to the AGV 10.

In the case that the notification indicates the remaining battery power Pi or Pj, the management device 50 records the value in a storage medium (at step S506). At this time, the management device 50 determines whether the remaining battery power Pi is greater than the threshold value A (at step S507). If Pi>A, the processing returns to step S503. If Pi≤A, the processing proceeds to step S505, where the management device 50 issues the alert and transmits a stop instruction to the AGV 10.

If the notification is a notification indicating completion of the travel, the management device 50 compares A against (Pi−Pj), and updates A to the greater value of the two (at step S508). After that, the management device 50 refers to the time information that is managed by the management device 50 itself and determines whether the date has changed (at step S509). If the date has not changed, 1 is added to n (at step S511), and the processing returns to step S503. If the date has changed, the alert threshold value B in the first cycle on the day is set to A×n, and the threshold value is recorded in the storage device or transmitted to the AGV 10 (at step S510). After that, the processing returns to step S503.

By the above-mentioned operation, the alert threshold values A and B can be updated daily. As a result, even when the battery 21 deteriorates over the duration of use, the threshold value for allowing an alert to be issued can be optimized automatically.

In the examples in FIG. 14 and FIG. 15, the AGV 10 compares the remaining battery power against the alert threshold value B only in the first cycle on each day. However, without being limited to these examples, the AGV 10 may perform also in the second and subsequent cycles the comparison determination processes shown in any of FIGS. 11 to 13, for example. The management device 50 is not limited to performing the operation shown in FIG. 15 but may also perform, for example, an operation similar to the determination processes shown in FIG. 13.

The above-mentioned operations are taken as examples, and the operations in the above-mentioned plurality of examples can be combined appropriately. The above-mentioned respective operations can be performed by executing the computer program stored in the storage medium using an integrated circuit, such as a CPU.

The above-mentioned comprehensive or specific embodiment may also be attained by a system, a method, an integrated circuit, a computer program or a storage medium. Alternatively, the embodiment may also be attained by arbitrarily combining a system, a device, a method, an integrated circuit, a computer program and a storage medium.

### INDUSTRIAL APPLICABILITY

The vehicle and the vehicle management system according to the present disclosure can be preferably used for moving and carrying goods, parts, finished products, etc. in factories, warehouses, construction sites, physical distribution bases, hospitals, etc.

While the present invention has been described with respect to exemplary embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A vehicle, performing travel along a route that is predetermined in a plurality of cycles, and the vehicle comprising:
an electrical storage device;
a driving device, configured to move the vehicle using an electric energy stored in the electrical storage device;
a communication circuit, configured to perform a wireless communication; and
a control circuit, configured to monitor a remaining energy of the electrical storage device and to control the driving device and the communication circuit,
wherein
when starting travel along the route, the control circuit compares the remaining energy of the electrical storage device against a threshold value, and causes the driving device to start the travel if the remaining energy exceeds the threshold value and causes the communication circuit to transmit an alert if the remaining energy does not exceed the threshold value, and
the threshold value is set based on an amount of energy consumed by at least one cycle of travel in the past.

2. The vehicle of claim 1, wherein
the threshold value is set to an amount of energy consumed by a preceding cycle of travel, or a largest value from among amounts of energy consumed by cycles of travel in the past.

3. The vehicle of claim 1, wherein
after a first cycle of travel is completed, the control circuit sets a first difference value between the remaining energy at a start time of the travel and the remaining energy at a completion time of the first cycle of travel as the threshold value, and
when starting a second cycle of travel, if the remaining energy is not more than the threshold value, the control circuit causes the communication circuit to transmit the alert.

4. The vehicle of claim 3, wherein
after the second cycle of travel is completed, if a second difference value between the remaining energy at a start time of the second cycle of travel and the remaining energy at a completion time of the second cycle of travel is greater than the threshold value, the threshold value is updated to the second difference value.

5. The vehicle of claim 1, further comprising:
a localization device, including an external sensor or an internal sensor, configured to estimate a position and an attitude of the vehicle based on a signal output from the external sensor or the internal sensor,
wherein
during each cycle of travel, the control circuit estimates a traveled distance from a start point based on the position which is estimated, calculates a progress rate α which is a rate of the traveled distance to a total distance to be traveled in the route, and when the remaining energy becomes equal to or less than a first value which is determined from the threshold value and the progress rate α, the control circuit causes the communication circuit to transmit the alert.

6. The vehicle of claim 5, wherein
when the remaining energy becomes equal to or less than the first value, the control circuit increases the threshold value by a second value which is determined from the progress rate α.

7. The vehicle of claim 1, wherein
the control circuit daily records a number of cycles of travel, and
the threshold value to be referenced in a first cycle in a day is set to a total energy that was consumed by all of the cycles of travel performed on a previous day or on a day before the previous day, or to a value proportional to the number of cycles of travel performed on the previous day or on the day before the previous day.

8. The vehicle of claim 1, wherein
the vehicle performs the travel along the route according to an instruction from an external device,
the external device daily records a number of cycles of travel, and
the threshold value to be referenced in a first cycle in a day is set to a total energy that was consumed by all of the cycles of travel performed on a previous day or on a day before the previous day, or to a value proportional to the number of cycles of travel performed on the previous day or on the day before the previous day.

9. A method for controlling a vehicle which performs travel along a route that is predetermined in a plurality of cycles, wherein
the vehicle comprising:
an electrical storage device;
a driving device, configured to move the vehicle using an electric energy stored in the electrical storage device; and
a communication circuit, configured to perform a wireless communication,
the method comprising:
when starting travel along the route, comparing a remaining energy of the electrical storage device against a threshold value, and causing the driving device to start the travel if the remaining energy exceeds the threshold value and causing the communication circuit to transmit an alert if the remaining energy does not exceed the threshold value, and
the threshold value is set based on an amount of energy consumed by at least one cycle of travel in the past.

10. A non-transitory computer readable medium, stored with a computer program for controlling a vehicle which performs travel along a route that is predetermined in a plurality of cycles, wherein
the vehicle comprising:
an electrical storage device;
a driving device, configured to move the vehicle using an electric energy stored in the electrical storage device; and
a communication circuit, configured to perform a wireless communication,
wherein the computer program causing a computer to execute:
when starting travel along the route,
comparing a remaining energy of the electrical storage device against a threshold value; and
causing the driving device to start the travel if the remaining energy exceeds the threshold value and causing the communication circuit to transmit an alert if the remaining energy does not exceed the threshold value, and
the threshold value is set based on an amount of energy consumed by at least one cycle of travel in the past.
